(19) United States
(12) Patent Application Publication
(10) Pub. No.: US 2006/0078408 A1
(43) Pub. Date: Apr. 13, 2006

(54) System for manufacturing a flat panel display

(75) Inventors: Won-Kie Chang, Seoul (KR); Gi-Cheon Yoon, Gyeonggi-do (KR); Geun-Soo An, Chungcheongnam-do (KR); Young-Min Kee, Chungcheongnam-do (KR)

Correspondence Address: PATENT LAW GROUP LLP, 2635 NORTH FIRST STREET, SUITE 223, SAN JOSE, CA, 95134, US

(73) Assignee: Samsung Electronics Co., LTD.

(21) Appl. No.: 11/246,360

(22) Filed: Oct. 7, 2005

(30) Foreign Application Priority Data
Oct. 8, 2004 (KR) 10-2004-0080228
Mar. 15, 2005 (KR) 10-2005-0021408
May 10, 2005 (KR) 10-2005-0038782

(51) Int. Cl. B65G 1/04

(52) U.S. Cl. 414/281

(57) ABSTRACT

An air current generated at a movement road does not flow into a shelf while a crane moves along the movement road since a system for manufacturing a flat display panel includes: a shelf positioned to both sides of a movement road, and accommodating a cassette; and a crane, moving along the movement road, transferring the cassette to the shelf and extracting the cassette therefrom; and a blocking pate mounted to both side portions of the crane so as to prevent air current from flowing into the crane.

### BACKGROUND OF THE INVENTION

(a) Field of the Invention

The present invention relates to a system for manufacturing a flat panel display, and in particular, a system for transporting a cassette from a process line to another process line.

(b) Description of Related Art

Generally, flat panel displays are widely used at present, and liquid crystal displays (LCDs), organic light emitting diode (OLED) displays, and so forth, are common types of flat panel displays.

Among them, a liquid crystal display includes a pair of panels, which include field generating electrodes formed thereon, and a liquid crystal layer disposed therebetween. Liquid crystal molecules of the liquid crystal layer are rearranged by voltages supplied to the electrodes, and accordingly an image is displayed by controlling transmittance of a light passing through the liquid crystal layer.

Such a liquid crystal display is manufactured as a plurality of substrates and is transported along a plurality of process lines. Particularly, a system for transporting a cassette is used so as to transport such substrates from one process line to another process line. The cassette accommodates a plurality of substrates.

A conventional system for transporting a cassette includes a movement road, a crane moving along the movement road after transferring the cassette thereinto, and a shelf accommodating the transported cassette.

An operation of a system for transporting a cassette will now be described.

The crane takes in the cassette from any one process line, and then, moving to a next process line along the movement road, the crane transfers the cassette into the shelf of the next process line.

However, since size of a glass substrate is tending to become larger, the conventional system for transporting a cassette has the following problems.

Foreign particles are more likely to be disposed on the glass substrate, and the size of the cassette becomes larger in accordance with the size of the glass substrate.

In addition, the crane transporting the cassette becomes bigger, that is, a sectional area of the crane becomes larger, and accordingly, turbulence is easily caused around the crane when the crane moves along a movement road

Accordingly, foreign particles from the movement road easily flow into the shelf due to the turbulence, and the foreign particles may be deposited on a circuit portion of the glass substrates. Consequently, the quality of a liquid crystal display may deteriorate.

### SUMMARY OF THE INVENTION

The present invention has been made in an effort to provide a system for manufacturing flat panel displays having an advantage of resolving the above-mentioned problems, and in addition, having an advantage that the air current generated at a movement road does not flow into a shelf while a crane moves along the movement road.

An exemplary system for manufacturing flat panel displays according to an embodiment of the present invention includes: a shelf positioned to both sides of a movement road, and accommodating a cassette; a crane, moving along the movement road, transferring the cassette to the shelf, and extracting the cassette therefrom; and a blocking pate mounted to both side portions of the crane so as to prevent air current from flowing into the crane.

In a further embodiment according to the present invention, the crane includes: a horizontal frame; a vertical frame vertically disposed on the horizontal frame; a moving part for moving the horizontal and vertical frames along the movement road; and a transferring part mounted to the vertical frame and transferring the cassette into the shelf and extracting the cassette from the shelf.

In another further embodiment according to the present invention, the transferring part includes: a horizontal supporter; and a robot arm mounted to an upper surface of the horizontal supporter, wherein the robot arm includes a rotating unit, the rotating unit comprises a driving axle and a rotation ring, and a Ferro fluid seal is provided between the driving axle and the rotation ring.

In another further embodiment according to the present invention, the crane further comprises a crane cover mounted to an outside surface of the vertical frame so as to cover the vertical frame.

In another further embodiment according to the present invention, the crane cover is formed into a streamline shape such that air resistance is reduced when the crane moves.

In another further embodiment according to the present invention, the crane cover includes a plurality of convexes formed on a surface thereof such that form drag is reduced when the crane moves.

In another further embodiment according to the present invention, the crane cover includes a plurality of concaves formed on a surface thereof such that form drag is reduced when the crane moves.

In another further embodiment according to the present invention, the crane cover is formed into a triangular shape such that air resistance is reduced when the crane moves.

The exemplary system for manufacturing flat panel displays according to an embodiment of the present invention further includes a rail of a wire type for guiding the crane, wherein: the crane further includes a guider of ring type mounted to an upper portion thereof, and the rail is inserted in the guider; and the rail and the guider only contact each other when needed.

In another further embodiment according to the present invention, the crane further includes an elevator mounted to the vertical frame and lifting the transferring the cassette up or down.

In another further embodiment according to the present invention, the elevator includes: at least two drive motors; and a drive belt connected to the drive motors, wherein the drive belt is formed of a dust-proof material such that particles are not generated when there is contact.

In another further embodiment according to the present invention, a first fan filter unit is further mounted to the horizontal supporter so as to discharge air after filtering foreign particles generated from the transferring part.

In another further embodiment according to the present invention, a second fan filter unit is further mounted to a lower portion of the vertical frame so as to discharge air after filtering foreign particles of an inside of the vertical frame.

In another further embodiment according to the present invention, a third fan filter unit is further mounted to a side surface of the vertical frame so as to discharge air after filtering foreign particles of an inside of the vertical frame.

In another further embodiment according to the present invention, a fourth fan filter unit is further mounted to the horizontal frame so as to discharge air after filtering foreign particles generated from the crane.

In another further embodiment according to the present invention, an intake hole is further formed to a portion corresponding to the guider of the vertical frame of the crane; and an intake fan is further mounted to an inside portion of the vertical frame of the crane so as to intake foreign particles through the intake hole.

In another further embodiment according to the present invention, an air passage is formed on the shelf, corresponding to one end of the shelf that is positioned to a front direction with respect to a movement direction of the crane, at both sides of the movement road.

In another further embodiment according to the present invention, a first exhaust fan is mounted to the air passage.

In another further embodiment according to the present invention, the shelf and the crane are positioned in a clean region; a grate is vertically formed to an inside of the shelf such that a vertical descending air current passes therethrough; and a fifth fan filter unit is mounted to a portion corresponding to the grate of an upper end of the shelf and forms the vertical descending air current such that foreign particles is prevent from flowing into the clean region.

In another further embodiment according to the present invention, a general region is positioned below a lower end of the shelf and is less clean than the clean region; the grate is extended to the general region; and a second exhaust fan is mounted to a portion poisoned to the general region of the grate such that air of the general region flows into the grate.

In another further embodiment according to the present invention, the crane further includes a servo box divided into two parts, and respectively mounted to both sides of the vertical frame of the crane.

In another further embodiment according to the present invention, the crane further includes at least two capacitor boxes arranged on the horizontal frame along a horizontal direction.

In another further embodiment according to the present invention, a first wear-proof member formed of a steel use stainless (SUS) material is disposed on a lower surface of the cassette.

In another further embodiment according to the present invention, a second wear-proof member formed of an SUS material is disposed on a cassette contact portion of the shelf.

In another further embodiment according to the present invention, the shelf is provided with a frame having a groove portion covered by a cover.

The exemplary system for manufacturing flat panel displays according to an embodiment of the present invention further includes an outside cover mounted to both ends of the movement road so as to prevent foreign particles from flowing into the movement road.

In another further embodiment according to the present invention, an exhaust hole is formed to the outside cover such that air current of the movement road exhausts therethrough.

In another further embodiment according to the present invention, the exhaust hole is formed to a lower portion of the outside cover.

In another further embodiment according to the present invention, an exhaust duct is mounted to the outside cover such that air current of the movement road exhausts therethrough.

In another further embodiment according to the present invention, the exhaust duct is mounted to a lower portion of the outside cover.

In another further embodiment according to the present invention, an exhaust damper is mounted to the outside cover such that air current of the movement road exhausts therethrough

In another further embodiment according to the present invention, the exhaust damper is mounted to a lower portion of the outside cover.

An exemplary system for manufacturing flat panel displays according to other embodiment of the present invention includes: a shelf positioned to both sides of a movement road, and accommodating a cassette; and a crane, moving along the movement road, transferring the cassette to the shelf, and extracting the cassette therefrom, wherein a crane cover with a predetermined shape is mounted to a predetermined portion of the crane such that either air resistance or form drag can be reduced when the crane moves.

An exemplary system for manufacturing flat panel displays according to another embodiment of the present invention includes: a shelf positioned to both sides of a movement road, and accommodating a cassette; a crane, moving along the movement road, transferring the cassette to the shelf, and extracting the cassette therefrom; and an outside cover mounted to both ends of the movement road so as to prevent foreign particles from flowing into the movement road, wherein an exhaust hole is formed to the outside cover such that air current of the movement road exhausts therethrough.

### BRIEF DESCRIPTION OF THE DRAWINGS

The present invention will become more apparent by describing preferred embodiments thereof in detail with reference to the accompanying drawings in which:

FIG. 1 is a perspective view of a system for transporting a cassette according to an embodiment of the present invention;

FIG. 2 is a perspective view of a cassette transported by a system for transporting a cassette according to an embodiment of the present invention;

FIG. 3 is a perspective view of a shelf of a system for transporting a cassette according to an embodiment of the present invention;

FIG. 4 is a longitudinal section of a crane of a system for transporting a cassette according to an embodiment of the present invention;

FIG. 5 is a perspective view of a crane of a system for transporting a cassette according to an embodiment of the present invention;

FIG. 6 is an enlarged view of a rotating unit of a crane of a system for transporting a cassette according to an embodiment of the present invention;

FIG. 7 is a perspective view showing a crane of a system for transporting a cassette according to a first variation of an embodiment of the present invention;

FIG. 8 is a perspective view showing a crane of a system for transporting a cassette according to a second variation of an embodiment of the present invention;

FIG. 9 is a perspective view showing a crane of a system for transporting a cassette according to a third variation of an embodiment of the present invention;

FIG. 10 is a top plane view showing a principal portion in FIG. 9;

FIG. 11 is a top plane view showing a principal portion of a crane of a system for transporting a cassette according to a forth variation of an embodiment of the present invention;

FIG. 12 is a front view of a crane of a system for transporting a cassette according to an embodiment of the present invention;

FIG. 13 is a top plan view of a system for transporting a cassette according to an embodiment of the present invention;

FIG. 14 is a front view of a system for transporting a cassette according to an embodiment of the present invention;

FIG. 15 is a longitudinal section of a shelf of a system for transporting a cassette according to an embodiment of the present invention;

FIG. 16 is a perspective view of a system for transporting a cassette according to an embodiment of the present invention, and it shows an outside cover further provided to the system;

FIG. 17 is a perspective view of a system for transporting a cassette according to a fifth variation of an embodiment of the present invention; and

FIG. 18 is a perspective view of a system for transporting a cassette according to a sixth variation of an embodiment of the present invention.

### DETAILED DESCRIPTION OF EMBODIMENTS

The present invention will be described more fully hereinafter with reference to the accompanying drawings, in which preferred embodiments of the invention are shown. This invention may, however, be embodied in many different forms and should not be construed as limited to the embodiments set forth herein.

A system for manufacturing a flat panel display according to an embodiment of the present invention will hereinafter be described in detail with reference to the drawings.

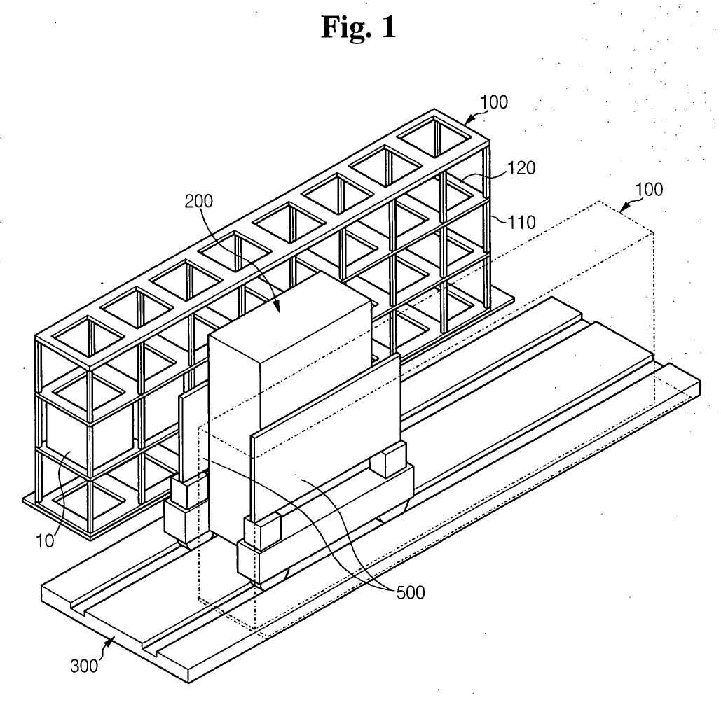

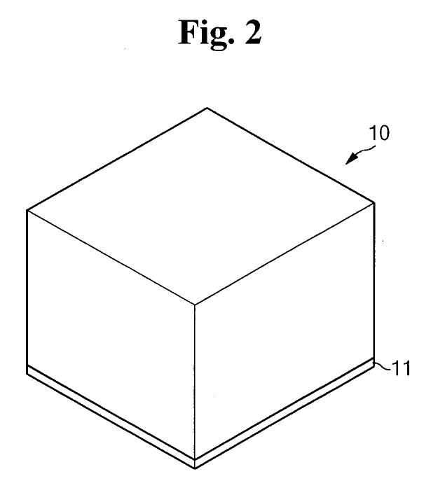

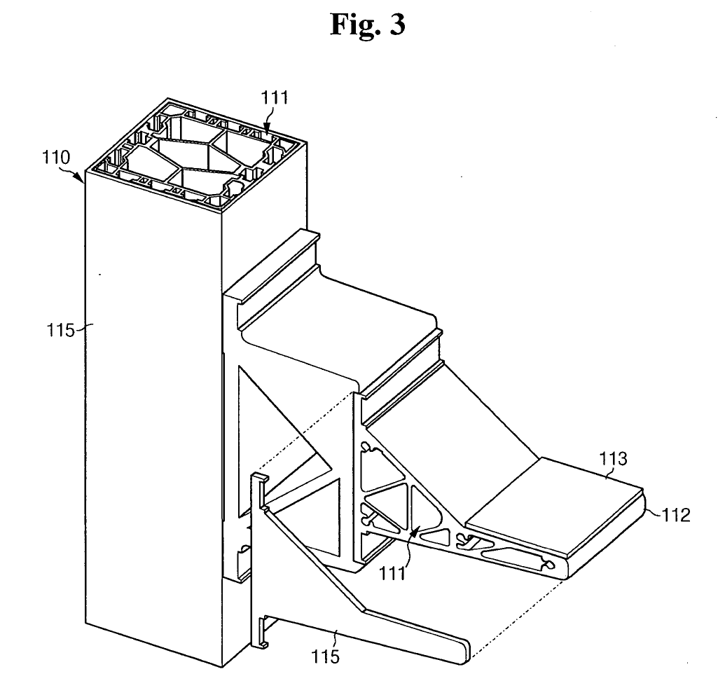

FIG. 1 is a perspective view of a system for transporting a cassette according to an embodiment of the present invention, FIG. 2 is a perspective view of a cassette transported by a system for transporting a cassette according to an embodiment of the present invention, and FIG. 3 is a perspective view of a shelf of a system for transporting a cassette according to an embodiment of the present invention.

As shown in FIG. 1, a system for transporting a cassette according to an embodiment of the present invention includes a shelf 100 positioned at both sides of a movement road 300 and accommodating a cassette 10, and a crane 200 moving along a movement road 300.

A shelf 100 is provided with a vertical frame 110 and a horizontal frame 120. Such vertical and horizontal frames 110 and 120 are formed of aluminum (Al) with electrical conductibility.

The cassette 10 may be formed of aluminum, and includes a first wear-proof member 11 disposed on a lower surface thereof, as shown in FIG. 2. The first wear-proof member 11 is formed of a poly carbonate or a steel use stainless (SUS) material. Accordingly, when the cassette 10 contacts the shelf 100 after the cassette 10 is transferred into the shelf 100, wear due to the contact is prevented by the first wear-proof member 11. In addition, the first wear-proof member 11, formed of the poly carbonate or SUS material, and the frames 110 and 120 of the shelf 100, formed of Al, have electrical conductibility, and accordingly, static electricity of the cassette 10 is prevented by grounding the shelf 100, when the cassette 10 is in contact with the shelf 100.

As shown in FIG. 3, the shelf 100 includes a cassette contact portion 112 directly contacting the cassette 10, a groove portion 111 for reinforcing a strength of the frames 110 and 120, and a cover 115 covering an exterior surface of the frames 110 and 120.

The second wear-proof member 113 of an SUS material is disposed on an upper surface of the cassette contact portion 112 so as to minimize particles that may be generated by a possible wear on contact with the first wear-proof member 11. The cover 115 prevents the foreign particles from flowing into the groove portion 111.

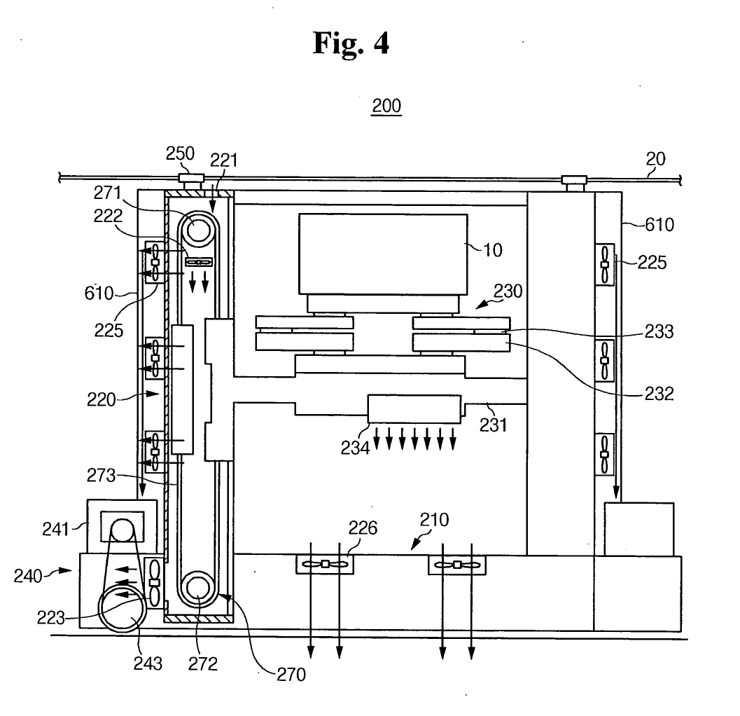

The crane will hereinafter be described in detail with FIGS. 4 to 6.

The crane 200 takes in the cassette 10 from any one process line, then, moving to a next process line, the crane 200 extracts the cassette 10 from the shelf 100 or transfers the cassette 10 to the shelf 100.

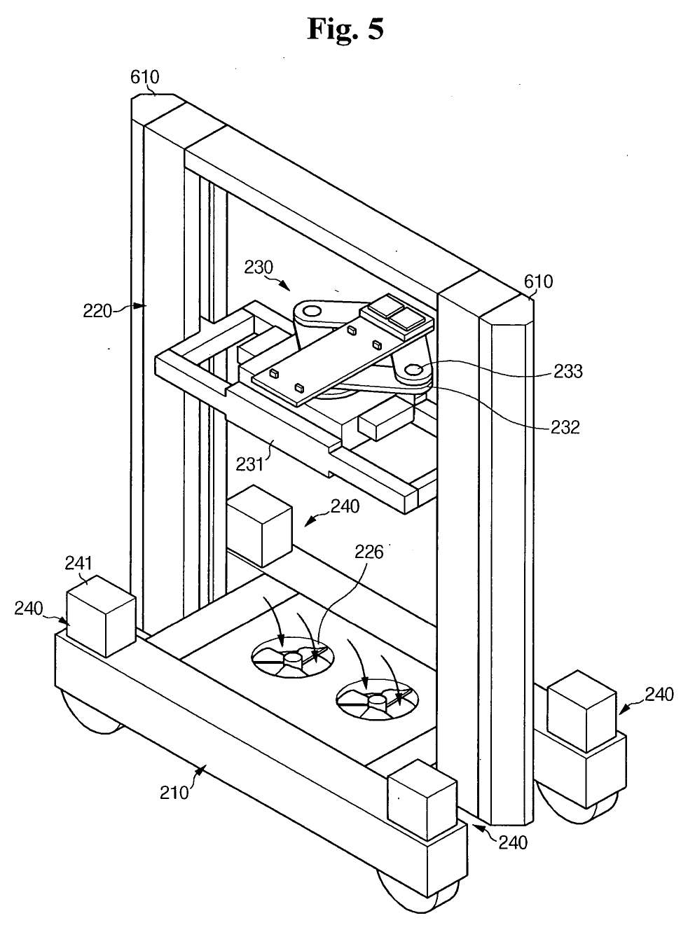

FIG. 4 is a longitudinal section of a crane of a system for transporting a cassette according to an embodiment of the present invention, and FIG. 5 is a perspective view of a crane of a system for transporting a cassette according to an embodiment of the present invention.

As shown in FIGS. 4 and 5, the crane 200 includes a horizontal frame 210, a vertical frame 220, a transferring part 230, a moving part 240, and an elevator 270.

The vertical frame 220 is mounted to an upper portion of the horizontal frame 210.

The moving part 240 includes a rotating unit 243, including a drive motor and a wheel, which is mounted to a lower portion of the horizontal frame 210. Accordingly, the crane 200 can move along the movement road 300.

The transferring part 230 transfers the cassette 10 from the shelf 100 into the crane 200 (or from the crane 200 into the shelf 100). Such a transferring part 230 includes a horizontal supporter 231, and a robot arm 232, which is mounted to an upper surface of the horizontal supporter 231, and has a rotating unit 233. Holding a lower surface of the cassette 10, the robot arm 232 takes in the cassette 10 from, or transfers the cassette 10 to, the shelf 100.

The elevator 270 raises or lowers the horizontal supporter 231. Such an elevator 270 includes a plurality of drive motors 271 and 272, a drive belt 273 connected to drive motors 271 and 272. Particularly, it is preferable that the drive belt 273 is formed of a dust-proof material so as to prevent generation of a particle.

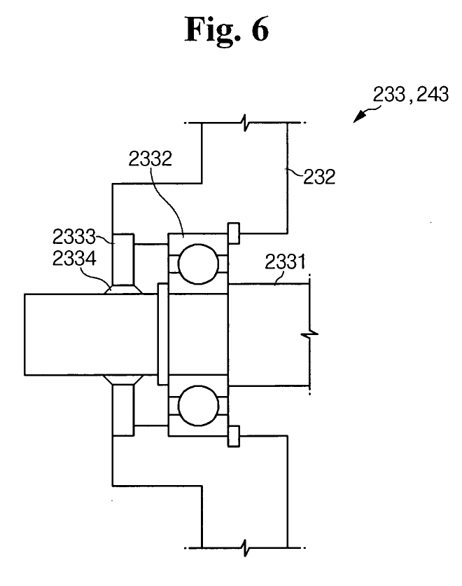

FIG. 6 is an enlarged view of a rotating unit of a crane of a system for transporting a cassette according to an embodiment of the present invention.

As shown in FIG. 6, the rotating unit 233 of the transferring part 230 includes a driving axle 2331, which includes a bearing 2332 and a rotation-ring 2333, such that the driving axle 2331 smoothly rotates. A rotating unit 243 of the moving part 240 comprises the same elements.

In addition, the Ferro fluid seal 2334 is provided between the driving axle 2331 and the rotation ring 2333. Such a Ferro fluid seal 2334 prevents particles generated in the rotating units 233 and 243 from flowing outside. It is preferable that the bearing 2332 is applied with a clean grease.

In addition, as shown in FIG. 4, particles generated in the transferring part 230 are filtered by a first fan filter unit (FFU) 234 such that only clean air may be discharged.

In addition, as shown in FIG. 4, it is preferable that a cover 241 is further mounted to the rotating unit 243 such that particles generated from the rotating unit 243 are not scattered.

As shown in FIG. 4, the crane 200 includes a guider 250 of a ring shape mounted to an upper portion thereof. A rail 20 of a wire type is mounted to an external part. The rail 20 is inserted in the guider 250. Such a guider 250 guides the crane 200 such that the crane 200 moves to a predetermined position along the rail 20.

Particularly, an interior circumference of the guider 250 is positioned apart from an exterior circumference of the rail 20 by a predetermined gap, so as to prevent possible generation of particles when the guider 250 contacts the rail 20. However, in an emergency, the guider 250 is allowed to contact the rail 20.

Also, as shown in FIG. 4, the vertical frame 220 of the crane 200 can include a second fan filter unit 223 mounted to a lower portion thereof. Accordingly, such a second fan filter unit 223 discharges clean air after filtering particles of an inside of the vertical frame.

In addition, the vertical frame 220 of the crane 200 further includes an intake vent 221 formed at a portion corresponding to the guider 250, and an intake fan 222 mounted therein. Accordingly, in the case that the guider 250 contacts the rail 20, particles generated due to the contact are absorbed into the vertical frame 220 through the intake vent 221, and the inflowing particles are filtered by a second fan filter unit 223 such that only the clean air may be extracted from the vertical frame 220.

On the other hand, it is preferable that a third fan filter unit 225 is further mounted to a side surface of the vertical frame 220. Such a third fan filter unit 225 can prevent particles generated due to the drive belt 273 from discharging into the transferring part 230. That is, since an internal pressure of the vertical frame 220 is decreased by the rotation of the third fan filter unit 225, the particles generated due to the drive belt 273 are not discharged into the transferring part 230 by such a pressure difference.

In addition, the vertical frame 220 of the crane 200 may further include a crane cover 610 mounted to the outside surface thereof. Furthermore, such crane cover 610 covers the third fan filter unit 225. Accordingly, air current of an inside of the vertical frame 220 is guided to a lower surface of the crane 200 by the third fan filter unit 225 and the crane cover 610. As a result, since the air current is guided to the lower surface of the crane 200, foreign particles can be further prevented from flowing into the transferring part 230.

In addition, such a crane cover 610 may be formed into a streamline shape such that air resistance is reduced when the crane 200 moves. The reason will hereinafter be explained in detail.

Since a cross section of the vertical frame 220 is a rectangular shape, air resistance is experienced by a front surface of the vertical frame 220 when the crane 200 moves. Because of such air resistance, a vortex broadly forms at a rear surface of the vertical frame 220, and foreign particles scattered by such a vortex pollute the substrate. Accordingly, if the crane cover 610 mounted to the front surface of the crane cover 200 is formed into the streamline shape, the vortex forming at the rear surface of the vertical frame 220 can be decreased, and consequently substrate pollution can be minimized. In addition, if the crane cover 610 is formed into the streamline shape, air current forming to the front surface of the vertical frame 220 is also not scattered, and accordingly substrate pollution can be further minimized.

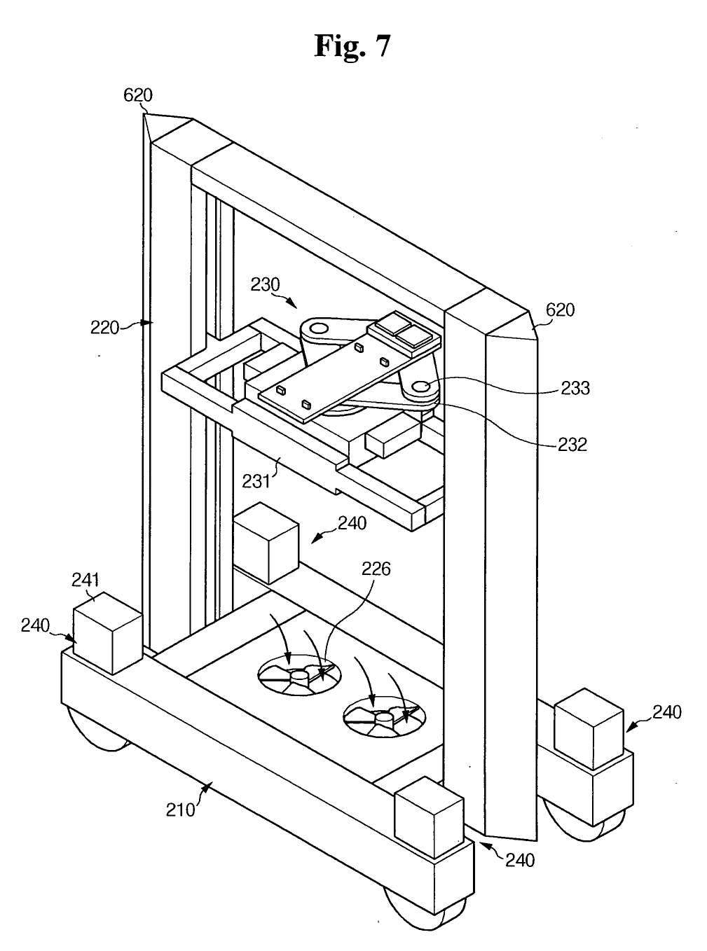

Several variations of a crane cover will hereinafter be explained with reference to the FIGS. 7 to 11.

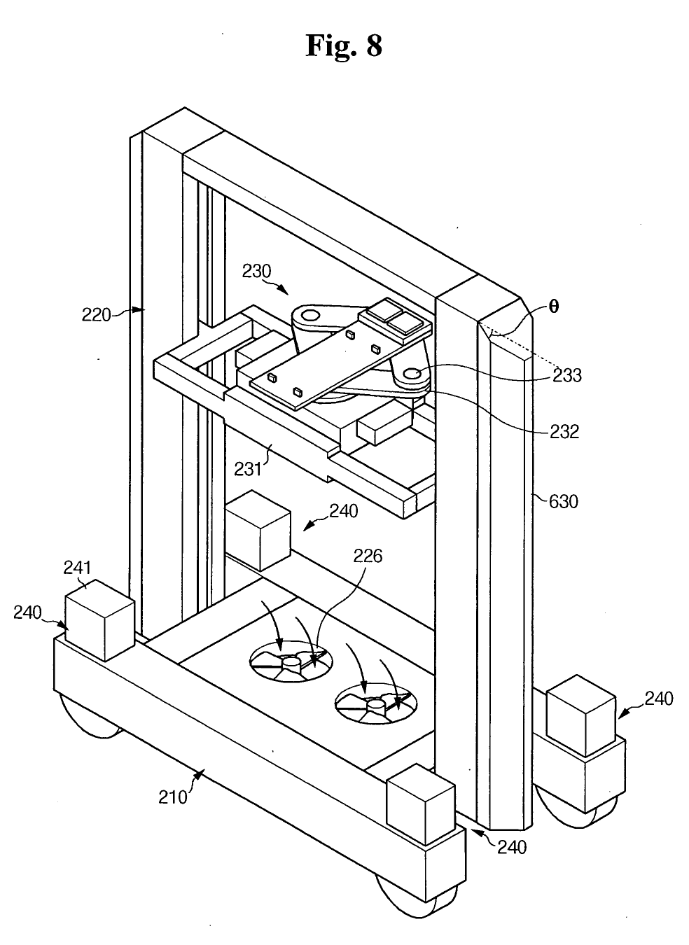

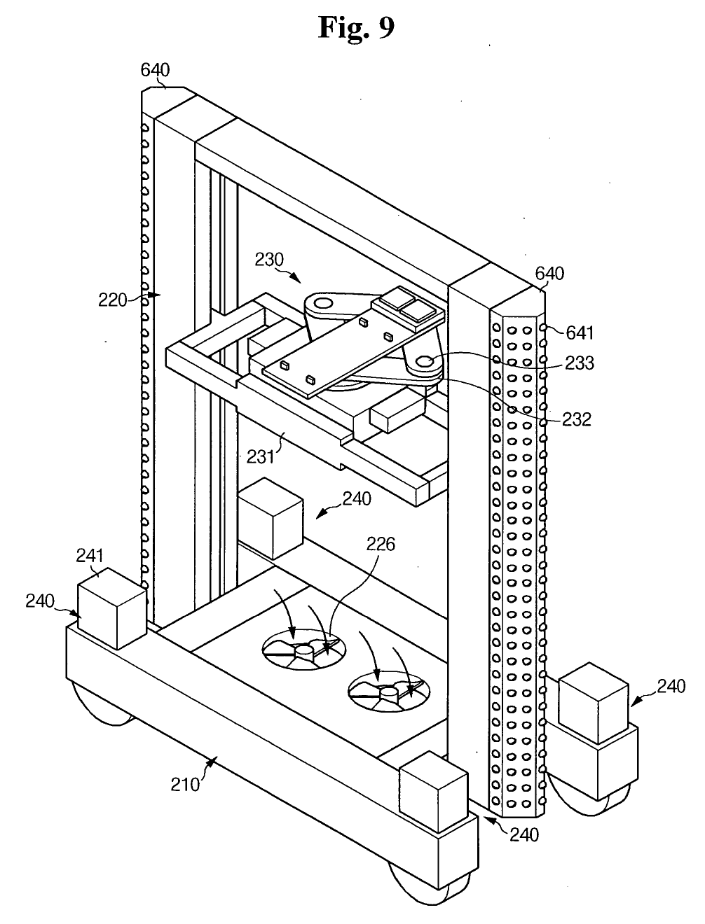

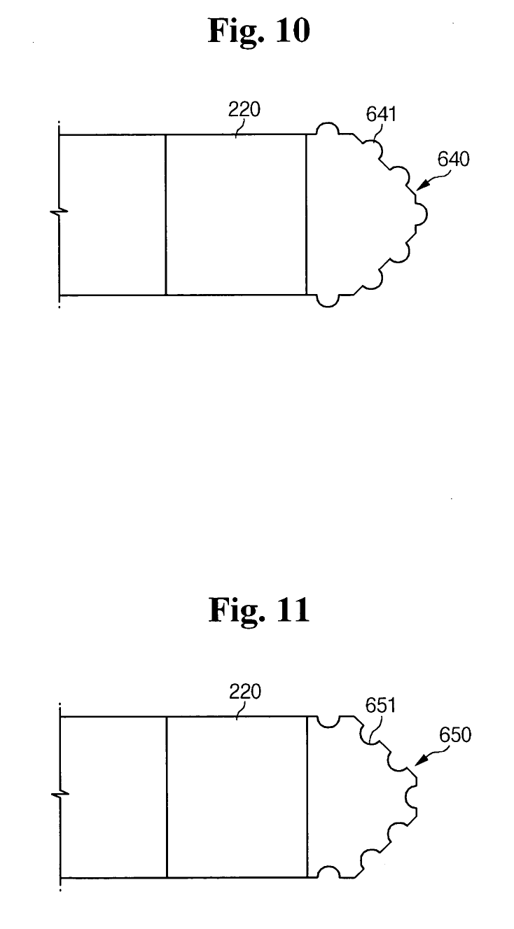

FIG. 7 is a perspective view showing a crane of a system for transporting a cassette according to a first variation of an embodiment of the present invention; FIG. 8 is a perspective view showing a crane of a system for transporting a cassette according to a second variation of an embodiment of the present invention; FIG. 9 is a perspective view showing a crane of a system for transporting a cassette according to a third variation of an embodiment of the present invention; FIG. 10 is a top plane view showing a principal portion in FIG. 9; and FIG. 11 is a top plane view showing a principal portion of a crane of a system for transporting a cassette according to a forth variation of an embodiment of the present invention.

As shown in FIG. 7, a crane of a system for transporting a cassette according to a first variation of an embodiment of the present invention includes a crane cover 620 with a triangular shape so as to reduce air resistance when the crane moves.

Accordingly, since the vortex forming to the rear surface of the vertical frame 220 can be decreased, substrate pollution can be minimized. In addition, since air current forming to the front surface of the vertical frame 220 is also not scattered, substrate pollution can be further minimized.

As shown in FIG. 8, a crane of a system for transporting a cassette according to a second variation of an embodiment of the present invention includes a crane cover 630 of which an upper portion is downwardly declined with a predetermined angle so as to reduce air resistance when the crane moves. In detail, the predetermined angle θ may be 20° to 60°. The crane cover 630 may be formed into either of a streamline shape or a triangular shape so as to reduce air resistance.

Accordingly, since the vortex forming to the rear surface of the vertical frame 220 can be decreased, substrate pollution can be minimized. In addition, since air current forming to the front surface of the vertical frame 220 is also not scattered, substrate pollution can be further minimized.

As shown in FIGS. 9 and 10, a crane of a system for transporting a cassette according to a second variation of an embodiment of the present invention includes a crane cover 640 which a plurality of convexes 641 are formed on a surface thereof so as to reduce form drag when the crane moves. The crane cover 640 may be formed into either of a streamline shape or a triangular shape so as to reduce air resistance.

Accordingly, since the vortex forming to the rear surface of the vertical frame 220 can be decreased, substrate pollution can be minimized. In addition, since air current forming to the front surface of the vertical frame 220 is also not scattered, substrate pollution can be further minimized.

As shown in FIG. 11, a crane of a system for transporting a cassette according to a second variation of an embodiment of the present invention includes a crane cover 650 which a plurality of concaves 651 are formed on a surface thereof so as to reduce form drag when the crane moves. The crane cover 650 may be formed into either of a streamline shape or a triangular shape so as to reduce air resistance.

Accordingly, since the vortex forming to the rear surface of the vertical frame 220 can be decreased, substrate pollution can be minimized. In addition, since air current forming to the front surface of the vertical frame 220 is also not scattered, substrate pollution can be further minimized.

On the other hand, as shown in FIGS. 4, 5, and 7 to 9, the crane 200 may include a plurality of fourth fan filter units 226 mounted to a lower portion of the crane 200. In order to remove foreign particles disposed on the crane 200, such fourth fan filter units 226 discharge the foreign particles into the lower surface of the crane 200 using strong suction force.

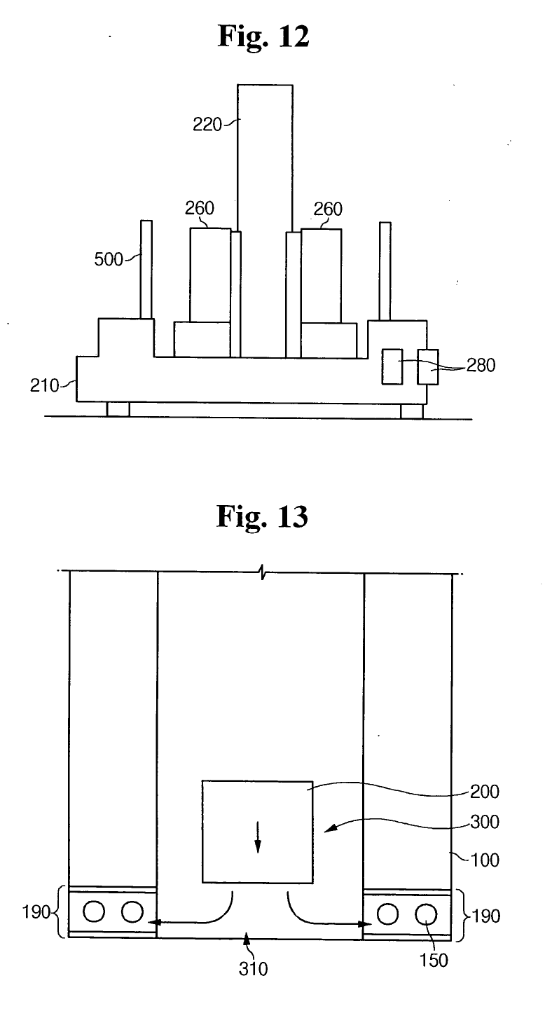

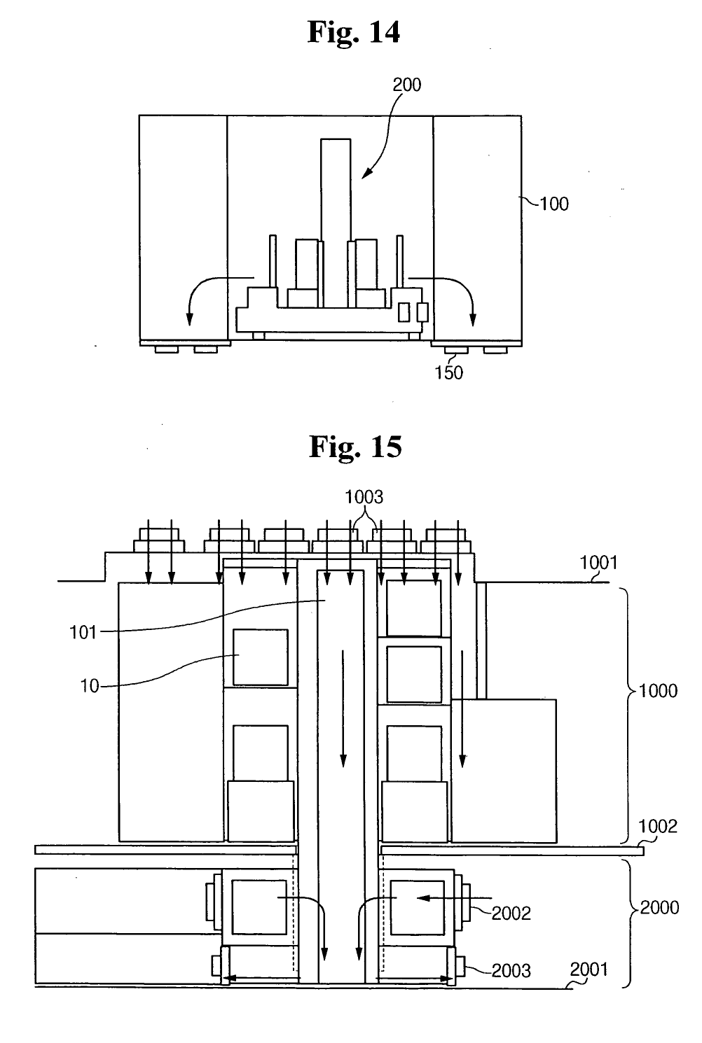

On the other hand, FIG. 12 is a front view of a crane of a system for transporting a cassette according to an embodiment of the present invention, and it shows a front side with respect to a movement direction of a crane. FIG. 13 is a top plan view of a system for transporting a cassette according to an embodiment of the present invention, FIG. 14 is a front view of a system for transporting a cassette according to an embodiment of the present invention, and FIG. 15 is a sectional view of a shelf of a system for transporting a cassette according to an embodiment of the present invention.

As shown in FIGS. 1 and 15, the system for transporting a cassette according to an embodiment of the present invention is divided into a clean region 1000 and a general region 2000 being less clean than the clean region 1000. Particularly, the shelf 100 and the crane 200 are positioned in the clean region 1000, and the clean region 1000 indicates a region between upper and lower ends of the shelf 100. The general region 2000 indicates a region lower than the lower end of the shelf 100. A plurality of grates 101 are vertically formed to inside of the shelf 100 such that a vertical descending air current passes therethrough

On the other hand, as shown in FIG. 13, an air current is generated when the crane 200 moves along the movement road 300, and flows into each shelf 100 respectively positioned to left and right sides of the front of the crane 200.

That is, as soon as the crane 200 moves along the movement road 300, the air current flows into the shelf 100, and as shown in FIG. 14, the inflowing air current vertically flows to a lower direction.

Such an inflow of the air current may be increased in cases where the crane 200 moves with a cassette 10, the crane 200 moves quickly, or the crane raises/lowers the cassette 10.

So as to prevent the air current from flowing into the shelf 100, as shown in FIG. 1 or 12, it is preferable that a blocking plate 500 is mounted to the both sides of the crane 200. Such a blocking plate 500 can minimize a problem in which particles contained in the air current flow into the shelf 100.

On the other hand, as shown in FIG. 13, the shelf 100 further includes an air passage 190 formed thereon. The air passage 190 is formed at a portion of the shelf 100 corresponding to a predetermined end 310 at both sides of a movement road 300. The predetermined end 310 is an end that is positioned to a front direction with respect to a movement direction of the crane 200. Such an air passage 190 extracts the air current that is generated while the crane 200 moves along the movement road 300.

However, since the air current is changed to turbulence when passing through the air passage 190, a slant angle of the descending air current becomes increased in a grate 101 of the shelf 100 communicated with the passage 190, and so the foreign particles may flow into the shelf 100. Consequently, it is preferable that the grate 101 has a big opening in comparison with another grate, so as to prevent such a phenomenon.

In addition, as shown in FIGS. 13 and 14, since a first exhaust fan 150 is mounted to the air passage 190, the vertical descending air current can be quickly removed. Accordingly, foreign particles are prevented from flowing into the shelf 100. In addition, such a first exhaust fan 150 prevents air current from flowing backward, while the crane 200 moves along the movement road 300.

On the other hand, as shown in FIG. 15, a plurality of fifth fan filter units 1003 are mounted to a portion corresponding to the grate 101 of the upper end 1001 of the shelf 100, such that foreign particles are not scattered to the clean region 1000. It is preferable that the fifth fan filter units 1003 are compactly mounted to the entire upper end 1001 of the shelf 100, such that the vertical descending air current is smoothly formed. Furthermore, as shown in FIG. 15, since second exhaust fans 2002 and 2003 are further mounted to a portion positioned to the general region 2000 of the grate 101, an external air current of the general region 2000 can flow into the grate 101 through the second exhaust fans 2002 and 2003.

Meanwhile, as shown in FIG. 12, a servo box 260 of the crane 200 is divided into two parts, and a size of the divided servo boxes is minimized. Thereafter, both servo boxes 260 are respectively mounted to a vicinity of both sides of the vertical frame 220. A size of capacitor boxes 280 is also minimized, and the capacitor boxes are arranged on the horizontal frame 210 along a horizontal direction. Accordingly, a sectional area of the crane 200 can be reduced by such a scheme. Consequently, an occurrence-probability of air current and turbulence is decreased since air resistance is reduced. Particularly, since a sectional area of an upper portion of the crane 200 is significantly reduced, an occurrence-probability of air current that may be formed at the upper portion of the crane 200 can be remarkably decreased.

Further, although it is not shown in the drawings, a particle-count probe is mounted at a predetermined position, such as a vicinity of the movement road 300, an upper portion of the shelf 100, and so forth, so as to monitor an occurrence-probability of particles.

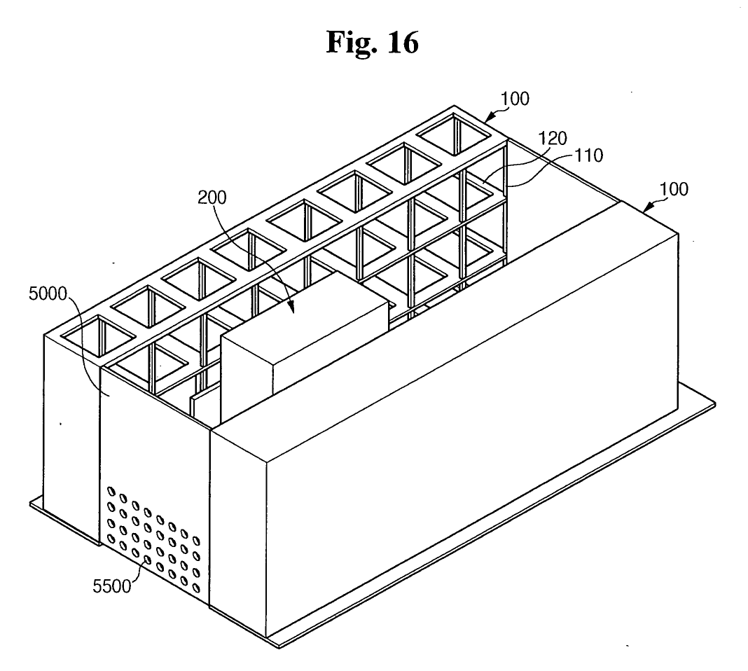

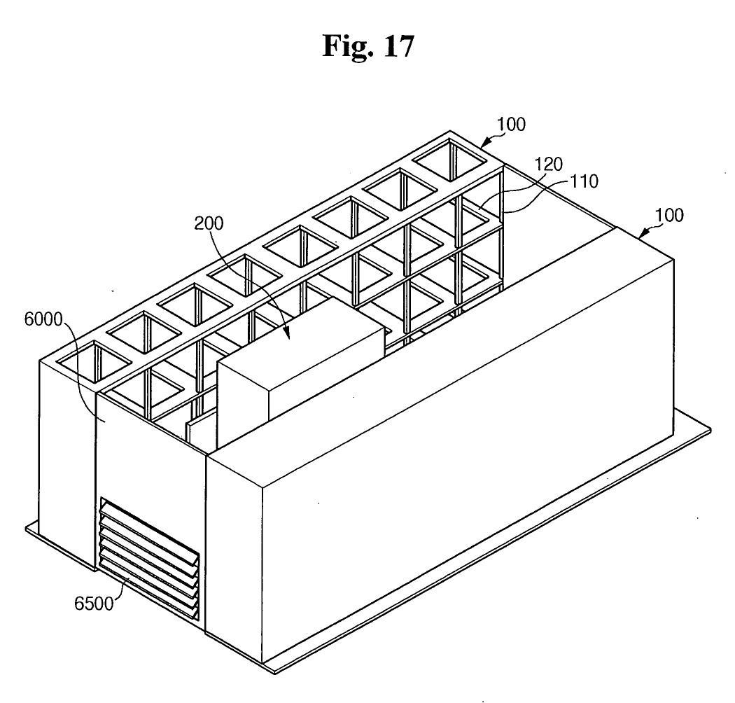

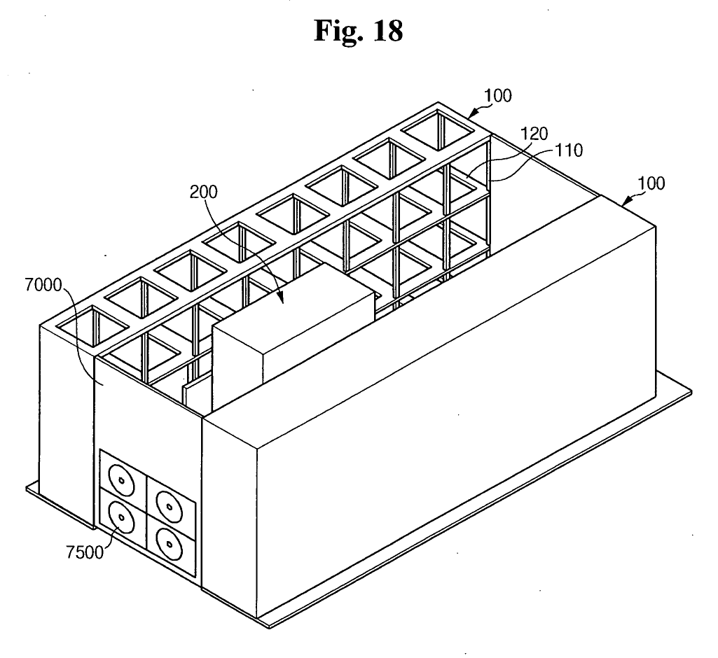

FIG. 16 is a perspective view of a system for transporting a cassette according to an embodiment of the present invention, and it shows an outside cover further provided to the system; FIG. 17 is a perspective view of a system for transporting a cassette according to a fifth variation of an embodiment of the present invention; and FIG. 18 is a perspective view of a system for transporting a cassette according to a sixth variation of an embodiment of the present invention.

As shown in FIG. 16, a system for transporting a cassette according to an embodiment of the present invention may further include an outside cover 5000 mounted to both ends of the movement road 300 so as to prevent foreign particles from flowing into the movement road 300. However, air current generated when the crane 200 moves toward an end of the movement road 300 changes into turbulence by striking against the outside cover 5000, and the foreign particles may flow into the cassette 10 of the shelf 100 because of such turbulence.

Accordingly, as shown in FIG. 16, in order to prevent such turbulence from generating, it is preferably that a plurality of exhaust holes 5500 are formed to the outside cover 5000. As a result, the air current generated when the crane 200 moves toward an end of the movement road 300 exhausts through the exhaust holes 5500 of the outside cover 5000.

However, the air current exhausted through the exhaust holes 5500 of the outside cover 5000 may flow into the movement road 300 through an upper portion of the outside cover 5000, and the inflowing air current may flow into the cassette 10 of the shelf 100. Accordingly, in order to prevent such a phenomenon, it is preferable that the plurality of exhaust holes 5500 is formed to a lower portion of the outside cover 5000.

As shown in FIG. 17, a system for transporting a cassette according to an embodiment of the present invention may further include an outside cover 6000 to which a plurality of exhaust ducts 6500 mounted, so as to prevent the above-mentioned turbulence from generating. As a result, the air current generated when the crane 200 moves toward an end of the movement road 300 exhausts through the exhaust ducts 6500 of the outside cover 6000.

However, the air current exhausted through the exhaust ducts 6500 of the outside cover 6000 may flow into the movement road 300 through an upper portion of the outside cover 6000, and the inflowing air current may flow into the cassette 10 of the shelf 100. Accordingly, in order to prevent such a phenomenon, it is preferable that the plurality of exhaust ducts 6500 are, as the above-mentioned exhaust holes 5500, formed to a lower portion of the outside cover 6000.

As shown in FIG. 18, a system for transporting a cassette according to an embodiment of the present invention may further include an outside cover 7000 to which a plurality of exhaust dampers 7500 mounted, so as to prevent the above-mentioned turbulence from generating. As a result, the air current generated when the crane 200 moves toward an end of the movement road 300 exhausts through the exhaust dampers 7500 of the outside cover 7000.

However, the air current exhausted through the exhaust dampers 7500 of the outside cover 7000 may flow into the movement road 300 through an upper portion of the outside cover 7000, and the inflowing air current may flow into the cassette 10 of the shelf 100. Accordingly, in order to prevent such a phenomenon, it is preferable that the plurality of exhaust dampers 7500 are, as the above-mentioned exhaust holes 5500, formed to a lower portion of the outside cover 7000.

As has been explained, a system for manufacturing a flat panel display according to an embodiment of the present invention has the following advantages.

According to an embodiment of the present invention, since a blocking plate is mounted to both sides of a crane, it can minimize an air current flowing into a shelf due to a movement of the crane.

In addition, according to an embodiment of the present invention, since an exhaust fan is mounted to an air passage, it can prevent an air current flowing backward due to a movement of the crane.

Also, according to an embodiment of the present invention, since a crane cover with a predetermined shape is mounted to front and rear surfaces of the crane, air resistance or form drag of the crane can be minimized while a crane moves, and consequently, substrate can be prevent from being polluted by foreign particles because turbulence is prevented from being generated.

Further, according to an embodiment of the present invention, since a plurality of fan filter units are mounted so as to discharge clean air after filtering foreign particles of an inside of a crane, a substrate can be prevent from being polluted by foreign particles.

Further, according to an embodiment of the present invention, since a cassette is formed of Al, a source of generating particles can be removed.

Further, according to an embodiment of the present invention, since an outside cover to which an exhaust holes are formed, air current generated by a movement of a crane does not flow into a shelf, and can smoothly exhaust through the exhaust holes of the outside cover.

Accordingly, rejection of a liquid crystal display due to foreign particles can be minimized.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims.

What is claimed is:

1. A system for manufacturing a flat panel display, comprising:
a shelf positioned to both sides of a movement road, and accommodating a cassette;
a crane, moving along the movement road, transferring the cassette to the shelf, and extracting the cassette therefrom; and
a blocking pate mounted to both side portions of the crane so as to prevent air current from flowing into the crane.

2. The system of claim 1, wherein the crane comprises:
a horizontal frame;
a vertical frame vertically disposed on the horizontal frame;
a moving part for moving the horizontal and vertical frames along the movement road; and
a transferring part mounted to the vertical frame and transferring the cassette into the shelf and extracting the cassette from the shelf.

3. The system of claim 2, wherein the transferring part comprises:
a horizontal supporter; and
a robot arm mounted to an upper surface of the horizontal supporter,
wherein the robot arm comprises a rotating unit,
the rotating unit comprises a driving axle and a rotation ring,
and a Ferro fluid seal is provided between the driving axle and the rotation ring.

4. The system of claim 2, wherein the crane further comprises a crane cover mounted to an outside surface of the vertical frame so as to cover the vertical frame.

5. The system of claim 4, wherein the crane cover is formed into a streamline shape such that air resistance is reduced when the crane moves.

6. The system of claim 5, wherein the crane cover includes a plurality of convexes formed on a surface thereof such that form drag is reduced when the crane moves.

7. The system of claim 5, wherein the crane cover includes a plurality of concaves formed on a surface thereof such that form drag is reduced when the crane moves.

8. The system of claim 4, wherein the crane cover is formed into a triangular shape such that air resistance is reduced when the crane moves.

9. The system of claim 8, wherein the crane cover includes a plurality of convexes formed on a surface thereof such that form drag is reduced when the crane moves.

10. The system of claim 8, wherein the crane cover includes a plurality of concaves formed on a surface thereof such that form drag is reduced when the crane moves.

11. The system of claim 2, further comprising a rail of a wire type for guiding the crane,
wherein: the crane further comprises a guider of ring type mounted to an upper portion thereof, and the rail is inserted in the guider; and
the rail and the guider only contact each other when needed.

12. The system of claim 2, wherein the crane further comprises an elevator mounted to the vertical frame and lifting the transferring the cassette up or down.

13. The system of claim 12, wherein the elevator comprises:
at least two drive motors; and
a drive belt connected to the drive motors,
wherein the drive belt is formed of a dust-proof material such that particles are not generated when there is contact.

14. The system of claim 3, wherein a first fan filter unit is further mounted to the horizontal supporter so as to discharge air after filtering foreign particles generated from the transferring part.

15. The system of claim 2, wherein a second fan filter unit is further mounted to a lower portion of the vertical frame so as to discharge air after filtering foreign particles of an inside of the vertical frame.

16. The system of claim 2, wherein a third fan filter unit is further mounted to a side surface of the vertical frame so as to discharge air after filtering foreign particles of an inside of the vertical frame.

17. The system of claim 2, wherein a fourth fan filter unit is further mounted to the horizontal frame so as to discharge air after filtering foreign particles generated from the crane.

18. The system of claim 11, wherein:
an intake hole is further formed to a portion corresponding to the guider of the vertical frame of the crane; and
an intake fan is further mounted to an inside portion of the vertical frame of the crane so as to intake foreign particles through the intake hole.

19. The system of claim 2, wherein an air passage is formed on the shelf, corresponding to one end of the shelf that is positioned to a front direction with respect to a movement direction of the crane, at both sides of the movement road.

20. The system of claim 19, wherein a first exhaust fan is mounted to the air passage.

21. The system of claim 1, wherein:
the shelf and the crane are positioned in a clean region;
a grate is vertically formed to an inside of the shelf such that a vertical descending air current passes therethrough; and
a fifth fan filter unit is mounted to a portion corresponding to the grate of an upper end of the shelf and forms the vertical descending air current such that foreign particles is prevent from flowing into the clean region.

22. The system of claim 21, wherein:
a general region is positioned below a lower end of the self and is less clean than the clean region;
the grate is extended to the general region; and
a second exhaust fan is mounted to a portion poisoned to the general region of the grate such that air of the general region flows into the grate.

23. The system of claim 2, wherein the crane further comprises a servo box divided into two parts, and respectively mounted to both sides of the vertical frame of the crane.

24. The system of claim 2, wherein the crane further comprises at least two capacitor boxes arranged on the horizontal frame along a horizontal direction.

25. The system of claim 1, wherein a first wear-proof member formed of a steel use stainless (SUS) material is disposed on a lower surface of the cassette.

26. The system of claim 1, wherein a second wear-proof member formed of an SUS material is disposed on a cassette contact portion of the shelf.

27. The system of claim 1, wherein the shelf is provided with a frame having a groove portion covered by a cover.

28. The system of claim 1, further comprising an outside cover mounted to both ends of the movement road so as to prevent foreign particles from flowing into the movement road.

29. The system of claim 28, wherein an exhaust hole is formed to the outside cover such that air current of the movement road exhausts therethrough.

30. The system of claim 29, wherein the exhaust hole is formed to a lower portion of the outside cover.

31. The system of claim 28, wherein an exhaust duct is mounted to the outside cover such that air current of the movement road exhausts therethrough.

32. The system of claim 31, wherein the exhaust duct is mounted to a lower portion of the outside cover.

33. The system of claim 28, wherein an exhaust damper is mounted to the outside cover such that air current of the movement road exhausts therethrough

34. The system of claim 33, wherein the exhaust damper is mounted to a lower portion of the outside cover.

35. A system for manufacturing a flat panel display, comprising:
a shelf positioned to both sides of a movement road, and accommodating a cassette; and
a crane, moving along the movement road, transferring the cassette to the shelf, and extracting the cassette therefrom,
wherein a crane cover with a predetermined shape is mounted to a predetermined portion of the crane such that either air resistance or form drag can be reduced when the crane moves.

36. A system for manufacturing a flat panel display, comprising:
a shelf positioned to both sides of a movement road, and accommodating a cassette;
a crane, moving along the movement road, transferring the cassette to the shelf, and extracting the cassette therefrom; and
an outside cover mounted to both ends of the movement road so as to prevent foreign particles from flowing into the movement road,
wherein an exhaust hole is formed to the outside cover such that air current of the movement road exhausts therethrough.
